(19) United States
(12) Patent Application Publication
(10) Pub. No.: US 2003/0010284 A1
(43) Pub. Date: Jan. 16, 2003

(54) Glueing device in bookbinding

(75) Inventors: Masatoshi Nishikawa, Aichi (JP); Katsuyasu Itoh, Kyoto (JP); Hajime Nishimura, Saitama (JP); Junji Chatani, Saitama (JP)

Correspondence Address: ROTHWELL, FIGG, ERNST & MANBECK, P.C., 1425 K STREET, N.W., SUITE 800, WASHINGTON, DC, 20005, US

(73) Assignee: DYNIC CORPORATION, Kyoto (JP)

(21) Appl. No.: 10/117,051

(22) Filed: Apr. 8, 2002

(30) Foreign Application Priority Data
Jul. 11, 2001 (JP) P2001-211004
Jul. 11, 2001 (JP) P2001-211002

(51) Int. Cl. B05C 1/00

(52) U.S. Cl. 118/258; 118/693

(57) ABSTRACT

Disclosed is a glueing device for adhesive bookbinding of a page stack (A) to a cover sheet (B), which comprises a housing (65) for containing hot melt adhesive (61′) in a molten state; a coating roller (64) with a periphery, at least a part of which is immersed in the molten adhesive in the housing, having an axial length substantially greater than a lengthwise size of the back surface of the page stack. The coating roller is rotatable about a shaft extending substantially in alignment with a center of thickness of the page stack. The glueing device further comprises a first drive mechanism (66) for achieving press-contact between the periphery of the coating roller and the back surface of the page stack to apply the molten adhesive on the periphery of the coating roller to the back surface of the page stack; and a second drive mechanism (67) for rotating the coating roller in forward and reverse directions over a predetermined small angle range, while the periphery of the coating roller is being in press-contact with the back surface of the page stack by the pressure applying mechanism, so that the molten adhesive effectively enters every interstice between adjacent pages from the back surface of the page stack. Accordingly, not only the back surface of the page stack but also opposing areas, in vicinity to the back surface, of the adjacent pages are coated with the molted adhesive for improved bonding therebetween.

### BACKGROUND OF THE INVENTION

1. Field of the Invention

The present invention relates to a glueing device in bookbinding for adhesive binding of a page stack to a cover sheet by using hot melt adhesive to be applied to a back surface of the page stack.

### PRIOR ART

Many attempts have been made to bind a page stack with a cover sheet by hot melt adhesive applied to a back surface of the page stack into a unitary assembled booklet. In one prior art bookbinding technic, a page stack and a cover sheet are separately transported to a glueing station where a back surface of the page stack, to which hot melt adhesive in a molten condition has been applied during conveyance thereof, is pressed against a center portion of the cover sheet for adhesive binding between the cover sheet and the page stack, followed by folding the cover sheet at lines spaced corresponding to thickness of the page stack for bookbinding into a unitary assembled booklet. A conventional glueing device for applying hot melt adhesive to the back surface of the page stack comprises a coating roller which is driven to rotate, about a shaft extending perpendicular to a travel path of the page stack, in a direction substantially opposite to a direction of travel of the page stack, so that a periphery of the coating roller carrying hot melt adhesive in a molten state is brought into contact under pressure with the back surface of the page stack.

A booklet D to be produced by the conventional glueing device is shown in FIG. 20, wherein there is an adhesive layer E between a back surface of a page stack F and a center portion of a cover sheet G but no adhesive enters interstices between pages H, H, . . . of page stack F, so that pages H, H, . . . are bonded to each other only at their back edge, which would easily be removed with a relatively small degree of a page peeling strength during use of booklet D.

To provide an improved adhesive strength between the cover sheet and the page stack, it is preferable that hot melt adhesive is not only applied to the back surface of the page stack but also enters every interstice between adjacent pages from the back surface of the page stack. The hot melt adhesive entering the interstice between adjacent pages is applied to opposing back edge portions of these pages, thereby bonding to each other. This will efficiently prevent some pages to fall away from a resulting booklet. However, the conventional glueing device of a coating roller type is only capable of applying the hot melt adhesive to the back surface of the page stack but no sufficient amount of the hot melt adhesive can enter the interstices between adjacent pages from the back surface of the page stack which is running along the travel path just above the coating roller.

### SUMMARY OF THE INVENTION

Accordingly, it is a primary object of the present invention to overcome the drawbacks and disadvantages of the prior art in a bookbinding technic and provide a novel and improved construction of a glueing device by which hot melt adhesive may effectively enter every interstice between adjacent pages from the back surface of the page stack so that not only the back surface of the page stack but also the opposing back edge portions of the adjacent pages are coated with the hot melt adhesive for improved bookbinding strength between the cover sheet and the page stack.

To achieve this and other objects, according to an aspect of the present invention, there is provided a glueing device for adhesive bookbinding of a page stack to a cover sheet, which comprises a housing for containing hot melt adhesive in a molten state; a coating roller with a periphery, at least a part of which is immersed in the molten adhesive in the housing, having an axial length substantially greater than a lengthwise size of the back surface of the page stack, said roller being rotatable about a shaft extending substantially in alignment with a center of thickness of the page stack; a first drive mechanism for achieving press-contact between the periphery of the coating roller and the back surface of the page stack to apply the molten adhesive on the periphery of the coating roller to the back surface of the page stack; and a second drive mechanism for rotating the coating roller in forward and reverse directions over a predetermined small angle range, while the periphery of the coating roller is being in press-contact with the back surface of the page stack by the pressure applying mechanism, so that the molten adhesive effectively enters every interstice between adjacent pages from the back surface of the page stack and, therefore, not only the back surface of the page stack but also opposing areas, in vicinity to the back surface, of the adjacent pages are coated with the molted hot melt adhesive for improved bonding therebetween.

The coating roller may be provided with a plurality of spaced, ringed grooves around the periphery thereof.

In a preferable embodiment of the present invention, the glueing device further comprises a adhesive supply unit for supplying the molten adhesive into the housing; a first sensor for detecting if the molten adhesive is contained in the housing above a first predetermined level; and a controller for controlling the adhesive supply unit such that it drives the adhesive supply unit for supplementation of the molten adhesive in the housing when the first sensor detects that a quantity of the molten adhesive in the housing does not reach the first predetermined level, whereas it makes the adhesive supply unit inoperative when the first sensor detects that the molten adhesive is contained in the housing above the first predetermined level.

In this preferable embodiment, there may further be provided with a second sensor for detecting if the molten adhesive is contained in the housing above a second predetermined level, higher than the first predetermined level, wherein the adhesive supply unit is stopped by the controller when the second sensor detects that the molten adhesive is contained in the housing above the second predetermined level.

### BRIEF DESCRIPTION OF THE DRAWINGS

Other objects and advantages of the present invention can be understood from the following description when read in conjunction with the accompanying drawings in which:

FIG. 1 is a block diagram of a bookbinding including an adhesive applicator according to the present invention;

FIG. 2 is a front view diagrammatically showing overall arrangement of a bookbinding device including a heater unit embodying the present invention;

FIG. 3 is an enlarged sectional view showing a sub-clamper and elements associated thereto of the bookbinding device of FIG. 2;

FIG. 4 is a perspective view showing leading end portions of the sub-clamper and a main damper of this bookbinding device, which also shows a manner of deliver of a page stack from the sub-clamper to the main clamper;

FIG. 5 is a plan view showing arrangement of this bookbinding device relating to the sub-clamper and a jog unit;

FIG. 6 is an enlarged plan view showing the sub-clamper and elements associated thereto;

FIG. 7 is an explanatory view showing a heater unit of this bookbinding device;

FIG. 8 is a front view showing a cutter unit and elements associated thereto of this bookbinding device;

FIG. 9 is a front view showing a scrap discharging unit of this bookbinding device;

FIG. 10 is a side view of the jog unit;

FIG. 11 is a front view of the jog unit;

FIG. 12 is a front view showing a cover positioning unit of this bookbinding device;

FIG. 13 is a flowchart showing page supply operation of this bookbinding device, the operation including supply of the page stack by the sub-clamper, jogging thereof by the jog unit and delivery thereof from the sub-clamper to the main clamper;

FIG. 14 is a flowchart showing successive operation of this bookbinding device, the operation including glueing to a back surface of the page stack, adhesive bonding of the page stack to a cover sheet and folding of the cover sheet;

FIG. 15 is a flowchart showing cover supply operation of this bookbinding device, the operation including trimming of the cover sheet, discharge of scraps and positioning of the trimmed cover sheet;

FIG. 16 is an explanatory view showing positioning of the cover sheet in its width directions;

FIG. 17(a) is a cross-sectional view showing a heater unit with an adhesive quantity controller and FIG. 17(b) is a plan view thereof;

FIG. 18(a) is a cross-sectional view showing a preferable design of a heater roll to be used in the heater unit and FIG. 18(b) is an enlarged cross-sectional view showing a periphery of the heater roll carrying a quantity of hot melt adhesive in a molten state;

FIG. 19 is an explanatory perspective view of a booklet produced by the bookbinding device of the present invention wherein each adjacent pages are stably bonded to one another by adhesive entering between adjacent pages from the back surface of the page stack during the glueing operation; and

FIG. 20 is an explanatory perspective view of a conventional booklet wherein pages of the page stack is bonded to each other only at their back edge.

### DETAILED DESCRIPTION OF THE PREFERRED EMBODIMENT

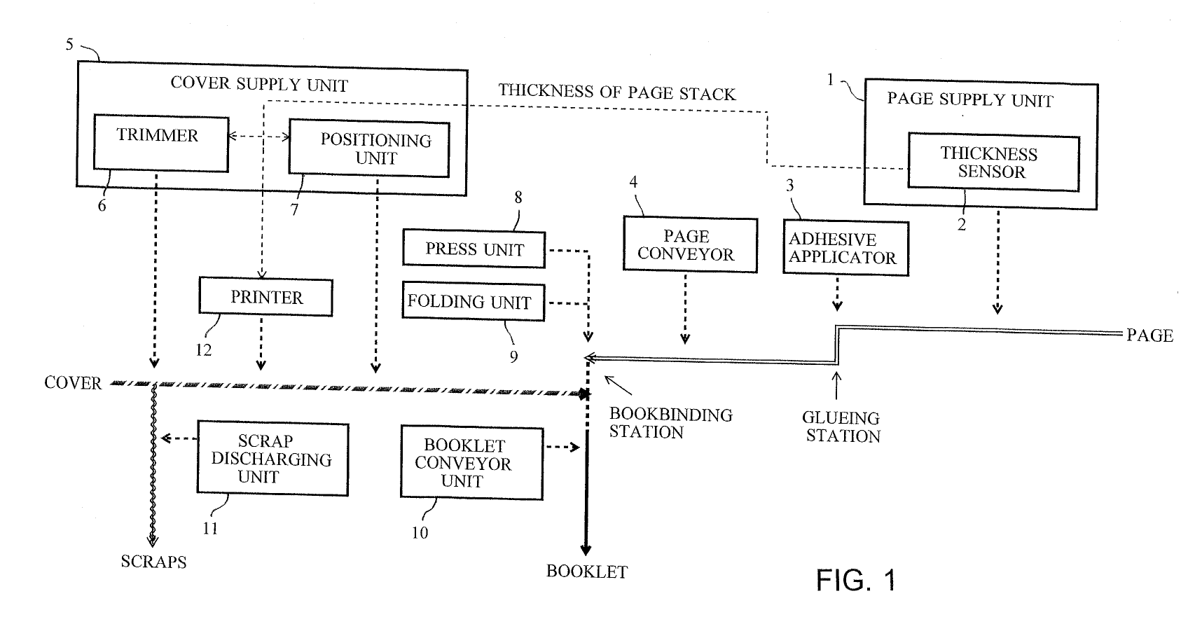

Referring first to FIG. 1, a bookbinding device comprises in general a page supply unit 1 including a thickness sensor 2, an adhesive applicator 3 according to the present invention, a page conveyor unit 4, a cover supplying unit 5 including a trimmer 6 and a positioning unit 7, a press unit 8, a cover folding unit 9, a booklet conveyor unit 10 and a scrap discharging unit 11.

Page supply unit 1 supplies a stack of pages to be bound to a first, glueing station. During supply to the glueing station, the page stack is kept in a clamped condition from opposite sides thereof. Sensor 2 detects thickness of the clamped page stack during supply thereof by page supply unit 1. Adhesive applicator 3 applies hot melt adhesive in a molten state to a back surface of the page stack which has been supplied to the glueing station by page supply unit 1. Page conveyor unit 4 conveys the page stack with the glued back surface from the glueing station to a second, bookbinding station.

Cover supply unit 5 supplies a cover sheet to beneath the glued back surface of the page stack at the bookbinding station. At this time, the page stack has been conveyed by page conveyor unit 4 and is positioned standstill at the bookbinding station. Trimmer 6 operates responsive to a result of detection by thickness sensor 2 to trim a side edge portion of the cover sheet depending upon thickness of the page stack. Positioning unit 7 operates also responsive to a result of detection by thickness sensor 2 to determine and control position of the cover sheet at the bookbinding station such that a center line of the trimmed cover sheet is aligned with a center of thickness of the page stack. Scrap discharging unit 11 discharges paper scraps produced after trimming through a scrap chute that is independent from a cover sheet travel path defined by cover supply unit 5.

Press unit 8 is adapted to contact under pressure the glued back surface of the page stack with a center portion of the cover sheet for adhesive binding therebetween. Cover folding unit 9 folds the cover sheet substantially along opposite side edges of the page stack to form a unitary assembled booklet. Such functions of press unit 8 and cover folding unit 9 may be achieved by a single unit or mechanism, as in an illustrated embodiment to be described hereinlater. The resulting booklet is discharged from booklet conveyor unit 10 toward a predetermined safekeeping station or the like.

A printer unit 12 may be of any known type, including ink jet type, by which any desired characters or images may be printed on the cover sheet. As described before, the cover sheet has been trimmed to a predetermined size really corresponding to the thickness of the page stack detected by sensor 2, so that a center of a cover page of a booklet to be produced can be determined with respect to the trimmed cover sheet. Printer unit 12 receives such center position data and operates in response to input of print command data to execute printing, without displacement of pattern printed on the cover page. This is especially useful in a full-page printing. According to the teachings of the present invention, printer unit 12 may be assembled in an automated bookbinding device, which should be compared with the prior art in which a printing step is carried out before a cover sheet is supplied to a bookbinding device.

Although not shown in FIG. 1, there is a control device such as a computer which receives the result of detection by sensor 2 to thereby controls operation of trimmer 6, positioning unit 7 and printer unit 12, respectively.

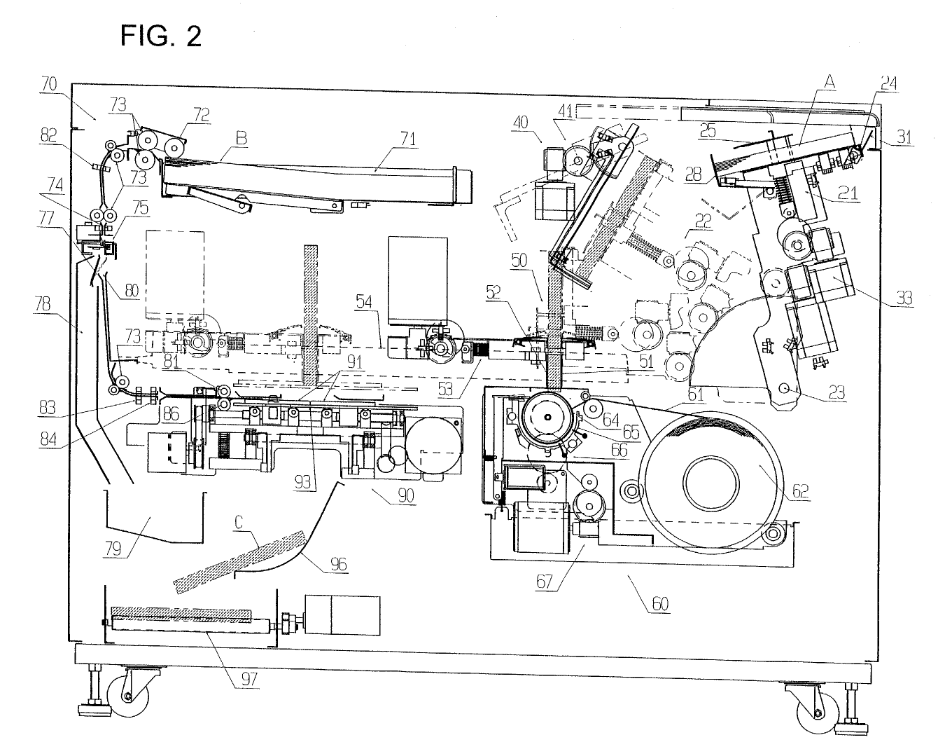

Reference should now be made to FIG. 2 illustrating a bookbinding device, which includes most elements shown in FIG. 1, including a glueing unit embodying the present invention, but does not have printer unit 12. In the embodiment of FIG. 2, page supply unit 1 (FIG. 1) comprises in main a sub-clamper 20 to which a thickness sensor 21 is attached.

Sub-clamper 20 is swingable about an axis 23 by a rotation drive mechanism 22. sub-clamper 20 is controlled by a controller, not shown, to swing between a stand-by position shown by solid lines where it awaits supply of a page stack, a jog position at an angle of approximately 60 degrees from the stand-by position in a counter-clockwise direction where the unclamped page stack is subjected to jogging operation, and a delivery position at an angle of approximately 30 degrees from the jog position in a counter-clockwise direction where the jogged page stack is delivered to a main damper 50.

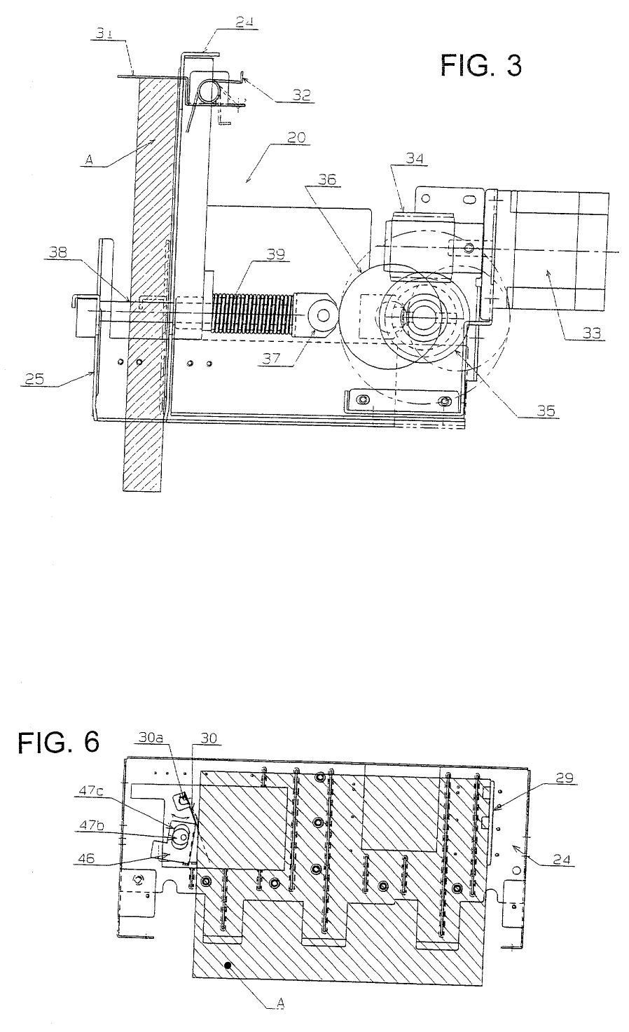

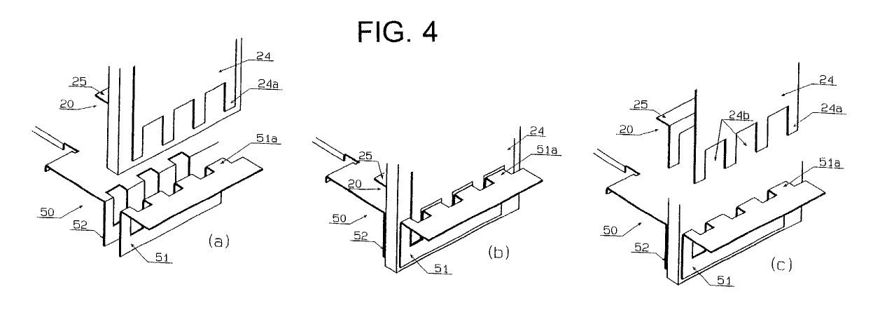

Sub-clamper 20 has a table 24 adapted to receive thereon a stack of pages A to be bound by this bookbinding device, a clamping plate 25 for holding the page stack A down to table 24, and an elevating mechanism, not indexed, for elevation of clamping plate 25 in a direction of thickness of the page stack A held between table 24 and clamping plate 25. An example of the elevating mechanism is shown in FIG. 3, which comprises a motor 33, a warm gear 34, a warm wheel 35, an eccentric cam 36, and a cam follower 37 always in contact with cam 36, a shaft 38 having one end connected to cam follower 37 and the other end connected to clamping plate 25. Rotation of motor 33 is transmitted via warm gear 34 and warm wheel 35 to eccentric cam 36. As eccentric cam 36 rotates, shaft 38 is moved in its axial direction to move clamping plate 25 with respect to table 24. A spring 39 around shaft 38 assures constant contact of cam follower 37 with a periphery of eccentric cam 36 and, in turn, provide a necessary clamping force to the page stack A when it is clamped between table 24 and clamping plate 25. As shown in FIG. 4, table 24 and clamping plate 25 respectively have teethed end portions comprising spaced projections 24a, 25a and recesses 24b, 25b defined between adjacent projections.

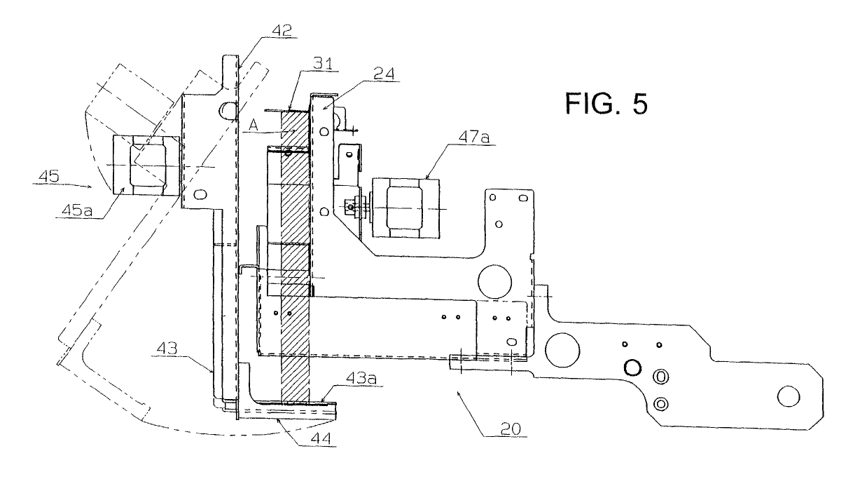

A ratable stopper 28 is provided near the front end, shown in FIG. 2 as a left-hand end, of table 24 for engaging the front edge of the page stack A placed on table 24. A stationary guide 29 engages one side edge of the page stack A whereas a movable guide 30 engage the other side edge thereof, as shown in FIG. 6. Stationary guide 29 is fixed to table 24. Movable guide 30 is biased by a spring, not shown, to rotate about an axis 30a in a counter-clockwise direction in FIG. 6 so that it always provide spring-biased contact with a left-hand side in FIG. 6 of the page stack A on table 24. Thus, the page stack A on table 24 may be held in definite position by cooperation of these guide members 29, 30, irrespective of thickness variation of the page stack A to be bound. Sub-clamper 20 is also provided with a rotatable press arm 31 for engaging the rear edge of the page stack A on table 24, as can be seen in FIG. 3 and FIG. 5. Arm 31 is biased by a coil spring 32 to rotate in a counter-clockwise direction in FIG. 5. Arm 31 is not only an element of page supply unit 1 (FIG. 1) but also an element of a jog unit 40 to be described hereinlater. Though not shown, sub-clamper 20 also includes a size sensor for detecting a size (A4, B5, . . . ) of the page stack A supplied onto table 24.

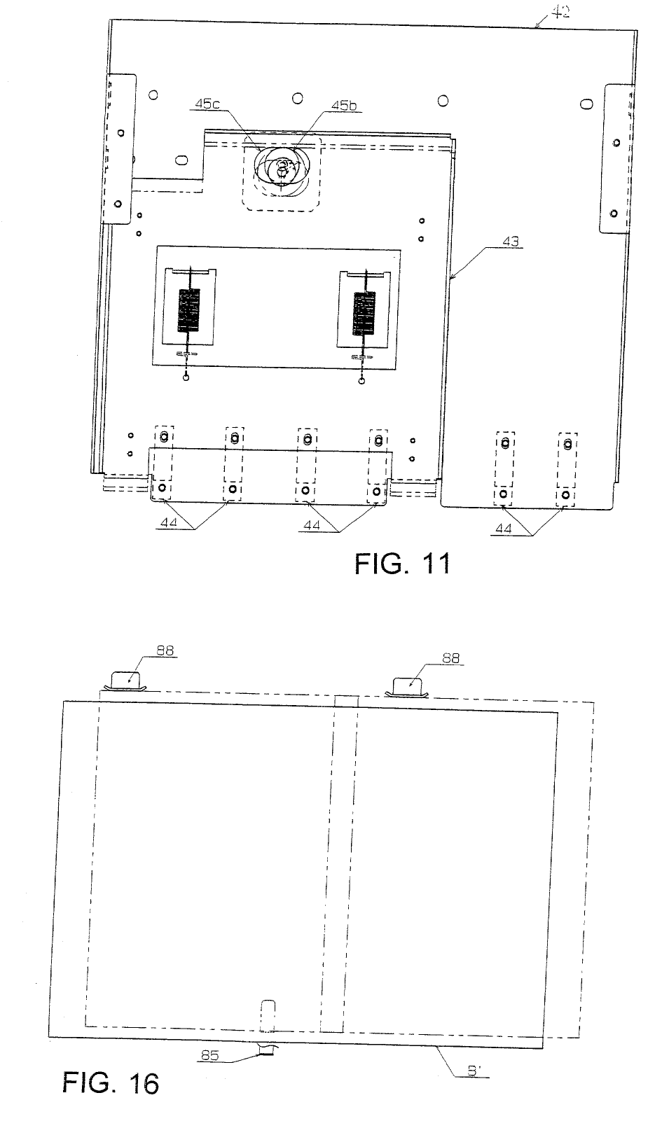

Referring to FIGS. 5, 6, 10 and 11, jog unit 40 is adapted to apply vibration or jogging movement to the page stack A clamped between table 24 and clamping plate 25 of sub-clamper 20, when sub-clamper 20 with the clamped page stack A has been moved by drive mechanism 22 from the stand-by position to the jog position. Jog unit 40 comprises a base arm 42 swingable by a drive mechanism 41 between a stand-by position shown by dotted lines in FIG. 2 and an operative position shown by solid lines in FIG. 2, an L-shaped jog plate 43 slidably connected to base arm 42, a positioning member 44 fixed to the lower end of base arm 42 and extends perpendicular to the plane of base arm 42, a vibration generator 45 for vibrating jog plate 43 with respect to and in parallel to base arm 42, the aforementioned press arm 31, a swingable piece 46 arranged near the left-hand edge (in FIG. 6) of the page stack A on table 24, and another vibration generator 47 for swinging piece 46 for intermittent collision with the left-hand edge of the page stack A.

Main clamper 50 is an principal element of page conveyor unit 4 (FIG. 1), which comprises a movable clamping plate 51, a stationary clamping plate 52, a drive mechanism 53 for moving plate 51 with respect to plate 52 to open and close main damper 50, and a shift mechanism 54 for laterally moving main damper 50. Drive mechanism 53 may be similar to the elevating mechanism in sub-clamper 20, which has been described in reference to FIG. 3.

Shift mechanism 54 is regulated such that main damper 50 takes three positions, that is, a page receiving position where the page stack A conveyed by sub-clamper 20 to the delivery position is delivered to main damper 50 in a manner described hereinbelow, a glueing position and a bookbinding position. In FIG. 2, the page receiving position of main clamper 50 is shown by solid lines, whereas its bookbinding position is shown by dotted lines. It is noted that the center of thickness of the upstanding page stack A clamped by main damper 50 in the page receiving position is somewhat offset to right, in FIG. 2, with respect to a center of a heater roll 64 to be described hereinlater. Though its glueing position is not shown in FIG. 2, it is to be understood that this position is in close vicinity to the page receiving position and, more specifically, may be obtained by slight parallel translation to left, in FIG. 2, from the page receiving position until the center of thickness of the upstanding page stack A clamped by main damper 50 is just aligned with the center of heater roll 64.

Similar to the end portions of table 24 and clamping plate 25 of sub-clamper 20, a pair of clamping plates 51, 52 respectively have teethed end portions comprising spaced projections 51a, 52a and recesses 51b, 52b defined between adjacent projections. However, such end portion arrangement of main damper 50 is complementary with respect to the end portion arrangement of sub-clamper 20, so that the teethed end portions of sub-clamper 20 and main damper 50 engage with each other. More specifically, as best seen in FIG. 4, when sub-clamper 20 has reached the delivery position, projections 24a, 25a of table 24 and clamping plate 25 which cooperate with each other to clamp the page stack A therebetween enter recesses 51b, 52b of clamping plates 51, 52 of main clamper 50 which has been waiting at the page receiving position, whereas projections 51a, 52a of main damper 50 go into recesses 24b, 25b of sub-clamper 20.

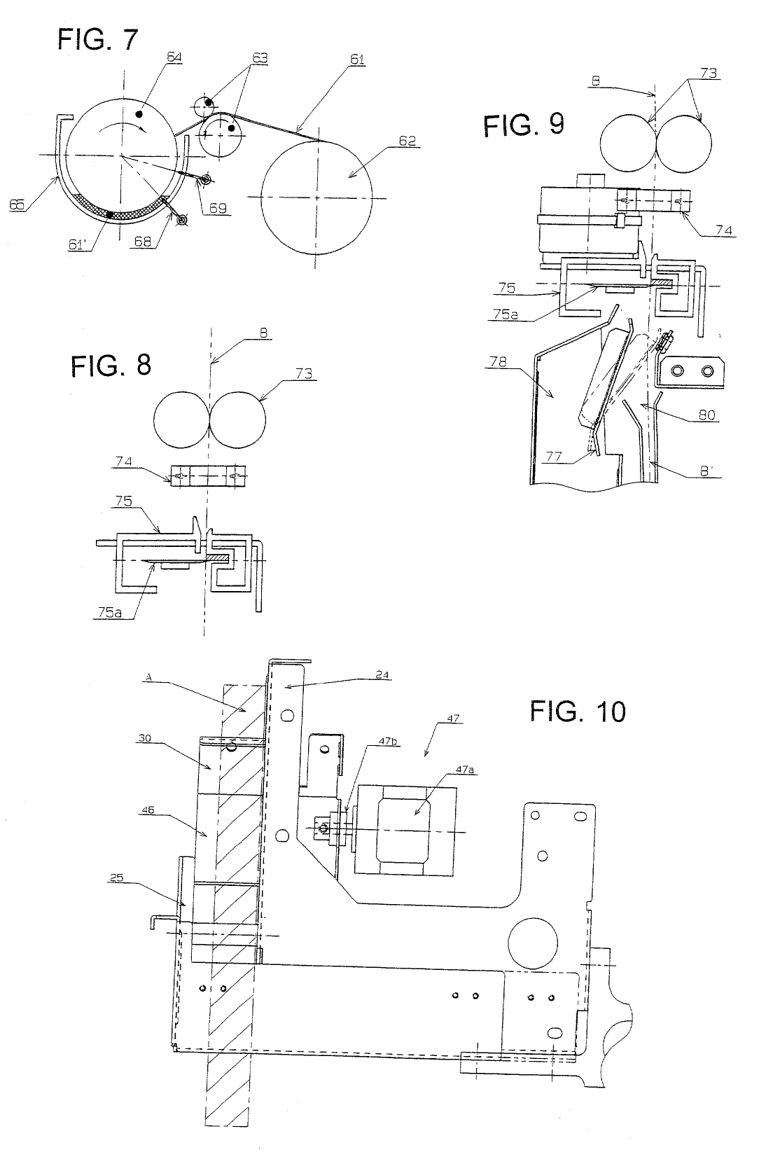

Adhesive applicator 3 (FIG. 1) is shown in the embodiment of FIG. 2 as a heater unit 60. Referring specifically to FIG. 7 as well as FIG. 2, heater unit 60 comprises a roller 62 from which a continuous sheet 61 of hot melt adhesive material is unreeled, a pair of feed rollers 63 for feeding hot melt adhesive sheet 61 along a predetermined travel path, a rotating heater roll 64 heated to above a melting point of hot melt adhesive material of sheet 61 and adapted to be in contact with a leading end of sheet 61 fed by feed rollers 63 for melting sheet 61, a housing 65 of an arcuate cross-section for receiving molten adhesive 61′, a drive mechanism 66 for rotating heater roll 64 in a predetermined direction, that is in a clockwise direction in FIGS. 2 and 7, and another drive mechanism 67 for elevation of heater roll 64. The adhesive 61 is melt by contact with a periphery of heater roll 64 to drip downward the bottom of housing 65 as shown by a hatched area in FIG. 7. The molten adhesive 61′ in housing 65 is adhered to the periphery of rotating heater roll 64 as the latter is rotating clockwise in FIG. 7, which is then transferred to the back surface and surrounding area on opposite sides of each page of stack A clamped by main damper 50 which has been transported from the stand-by position to the glueing position where a center of thickness of the clamped page stack A is just aligned above with a vertical center line of heat roller 64.

In a modified embodiment, there is provided a cutter just before a point of contact between hot melt adhesive sheet 61 fed by feed rollers 63 and the periphery of heater roll 64, for cutting a forward end portion of sheet 61 into a relatively short strip which falls down into the interior of housing 65. This is particularly suitable in a case where momentary contact or collision with heater roll 64 is not sufficient to transform sheet 61 into a molten state. Housing 65 is heated to above a melting point of hot melt adhesive materia of sheet 61 so that a short strip falling down one another will soon be transformed into molten adhesive 61′ which is contained in housing 65.

Housing 65 is provided with temperature sensors 68, 69 at different levels to confirm that a predetermined quantity range of the molten adhesive is contained in housing 65 from a difference of temperature detected by these sensors.

More specifically, sensor 68 positioned at a lower level is to detect if a predetermined minimum quantity of molten adhesive 61′ is contained in housing 65, which is turned on when it detects a temperature (that is approximately 180° C., for example) higher than the melting point of hot melt adhesive material of sheet 61. When sensor 68 is turned off, which indicates lack of molten adhesive 61′ in housing 65, feed rollers 63 are driven to unreel sheet 61 so that the forward end portion of sheet 61 is brought into contact with the periphery of heater roll 64 for supplementation of molten adhesive 61′ in housing 65, until sensor 68 is turned on. When sensor 68 is turned on, indicating that a sufficient quantity of molten adhesive 61′ is now contained in housing 65, feed rollers 63 is de-energized. By such control, a quantity of molten adhesive 61′ in housing 65 is always sufficient.

However, too much content of molten adhesive 61′ in housing 65 would greatly deteriorate working environment due to billows of smoke and a pungent smell. It is, therefore, preferable that position of sensor 68 and temperature to be detected thereby should be determined so as to control a quantity of molten adhesive 61′ in housing 65. As will be described hereinlater in reference to FIG. 18, heater roll 64 having a plurality of spaced, ringed grooves 107 on the periphery thereof is proved to be a preferable design because it applies a practically sufficient quantity of adhesive 61′ not only to the back surface of page stack A but also to the surrounding areas on opposite sides of every page, even when a relatively small quantity of molten adhesive 61′ is contained in housing 65.

Sensor 69 at an upper level acts as a safeguard which is turned on when detecting a temperature (that is approximately 180° C., for example) higher than the melting point of hot melt adhesive material of sheet 61 to stop operation of the bookbinding device.

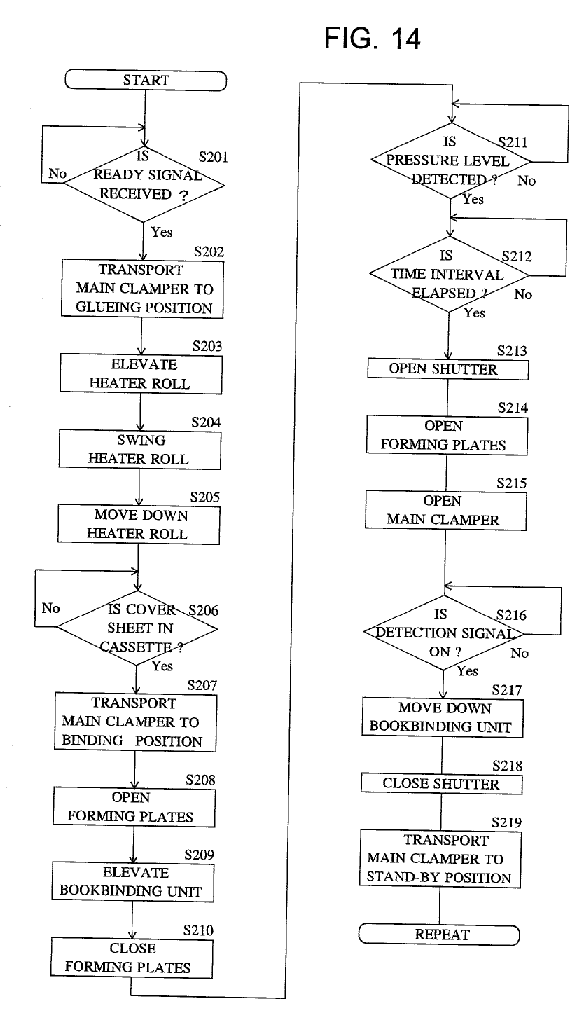

Usually, heater roll 64 is driven by a drive mechanism 66 to rotate clockwise, in FIG. 7, at a constant speed. During the glueing operation, drive mechanism 66 is controlled to rotate or swing in forward and reverse directions over a predetermined small angle (±5 degrees), by which a practically sufficient quantity of molten adhesive 61′ may be applied to the back surface of page stack A and the surrounding areas on opposite sides of every page. The glueing operation will be described in more detail in connection with steps S203-S205 of the flowchart of FIG. 14.

The glueing operation by heater unit 60 is controlled by a control unit such as a computer, not shown. For example, control unit controls in response to output from temperature sensors 68, 69 to drive and stop feed rollers 63. It also controls drive mechanism 66 for usual rotation in a predetermined direction, stop before commencing the glueing operation and swinging rotation in forward and reverse directions of heater roll 64 during the glueing operation. It also controls another drive mechanism 67 for elevation of heater rolls 64.

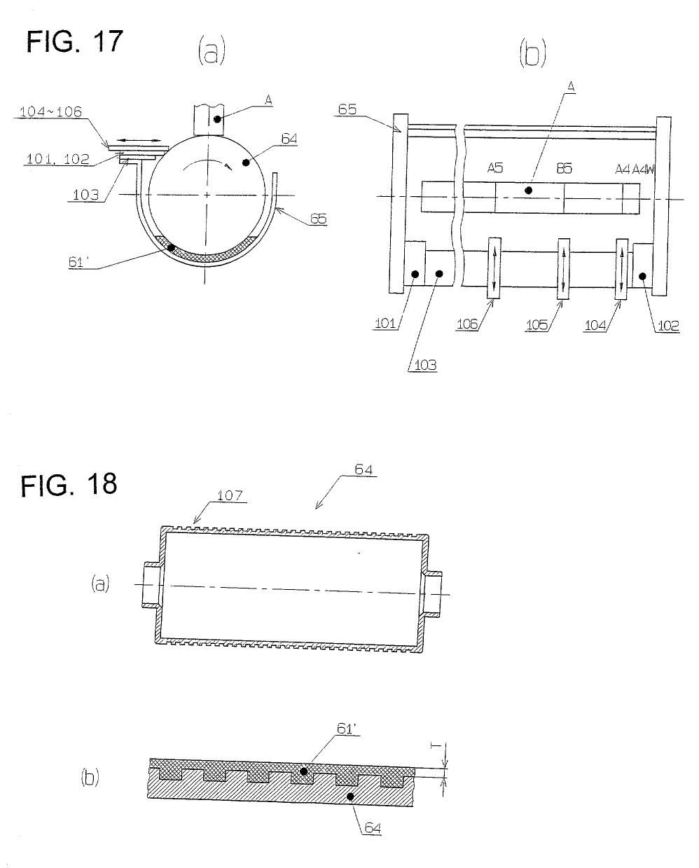

FIG. 17 illustrates another embodiment of heater unit which is provided with a controller for controlling a quantity of hot melt adhesive 61′ to be adhered to the periphery of heater roll 64. In this embodiment, at one of upper ends of housing 65 which is located beforehand of page stack A at the glueing position in a direction of rotation of heater roll 64, there are provided a pair of stationary guides 101, 102, a control knife 103 and a plurality of movable guides 104, 105, 106 between stationary guides 101, 102. Position and number of movable plates depend upon sizes (A4, B5, . . . ) of page stack A to be bound by this bookbinding device. There is a predetermined interval between a leading end of control knife 103 and the periphery of heater roll 64, as can be best seen in FIG. 1), for adjusting a quantity of hot melt adhesive 61′ to be applied to the back surface and the surrounding areas of page stack A.

In this embodiment, the bookbinding device is capable of binding a page stack A of size ranging from A5 and A4W. As best seen in FIG. 1), stationary guides 101, 102 are spaced to correspond an A4W size so that the glueing operation is carried out without using movable guides 104-106 when a page stack A of A4W size is to be bound. When a page stack A of A4 size is to be bound, movable guide 104 is moved toward the periphery of heater roll 64 to provide a space corresponding thickness of the A4-size page stack A is held between blades 101 and 104 during the glueing operation. Likewise, when a B5- or A5-size page stack A is subjected to bookbinding, movable guide 105 or 106 is moved to its operative position so that the back surface and the surrounding areas of each page of the B5- or A5-size page stack A may be coated with molten adhesive 61′ adhering on a peripheral area, restricted by stationary guide 101 and movable guide 105 or 106, of heater roll 64.

At the glueing position, one of the side edges of page stack A extends in contact along stationary guide 101, irrespective its size, and the other side edge is engaged by another stationary guide 102 or one of movable guides 104-106. hot melt adhesive 61′ adhering on the entire width of the periphery of heater roll 64 is partly removed by stationary guide 101 and stationary guide 102 or one of movable guides 104-106 to restrict the adhesive-adhering area to conform with the actual thickness of page stack A, while heater roll 64 is rotating clockwise, in FIG. 7. Removal of hot melt adhesive 61′ on heater roll 64 in a manner described above will prevent an excessive quantity of hot melt adhesive 61′ to be pushed out from the back surface of page stack A, when page stack A is pressed against cover sheet B at the bookbinding position.

Heater roll 64 is preferably provided with a plurality of ringed grooves 107, spaced by a predetermined interval in an axial direction, on the periphery thereof, as shown in FIG. 18. According to this embodiment, hot melt adhesive 61′ adheres on the periphery of heater roll 64 as of a coating layer of thickness T which is determined by a gap between the periphery of heater roll 64 and control knife 103, and is also contained in every groove 107.

Cover supply unit 5 (FIG. 1) is shown by a reference numeral 70 in the embodiment of FIG. 2, which comprises a cassette 71 that receives a stack of cover sheets B, a first feed roller 72 for feeding a cover sheet B, one by one, from cassette 71 at controlled time intervals, and a series of subsequent feed rollers 73 for feeding cover sheet B along a travel path toward trimmer 6, and further to the bookbinding station where the back surface of page stack A is bonded to the center portion of cover sheet B. The last feed roller is a positioning roller 81 to be described hereinlater, which constitutes positioning unit 7 (FIG. 1). Cover sheets B in cassette 71 have a predetermined size which depends upon the size (A4, B5, . . ) of pages A on table 24 to be bound. Cassette 71 may be adapted to receive some kinds of cover sheets B of different sizes, in which case there is preferably provided a size sensor for detecting the size of cover sheets B now received in cassette 71. Cover supply unit 5 also has a series of sensors for detecting that cover sheet B is actually fed along the predetermined travel path, including a cutter position sensor 74 to be described hereinlater and sensors 82-84.

Trimmer 6 (FIG. 1) is arranged along the travel path of cover sheet B defined by feed rollers 73, which comprises in the embodiment of FIG. 2 the above-described cutter position sensor 74 and a cutter 75 with a blade 75a, as shown in FIGS. 8 and 9. Cutter blade 75a is driven by a motor, not shown.

After being trimmed by cutter 75 to a predetermined size in reference to the thickness of page stack A to be bound, cover sheet B is then fed by a cover chute 80 and rollers 73 to a definite position which is determined by positioning unit 7. In the meantime, scraps produced by cutting cover sheet B by cutter 75 is discharged by scrap discharging unit 11 (FIG. 1) along a predetermined discharge path which is separate from the post-cutter travel path of cover sheet B. Scrap discharging unit 11 comprises in the embodiment of FIG. 2a changeover switch or rotatable flap 77 controlled in synchronism with operation of cutter 75, and a scrap chute 78 arranged in vicinity to cover chute 80 for discharging therethrough the scraps. At the time when cutter 75 operates to trim one side edge portion of cover sheet B, flap 77 is positioned as shown by dotted lines in FIGS. 2 and 9 to provide a greater opening at a top of scrap chute 78, just beneath cutter 75, for receiving the scraps falling down from cutter 75 and guiding them into scrap chute 78. Immediately after that, flap 77 is returned to a position shown by solid lines in FIGS. 2 and 9 to allow the trimmed cover sheet B′ to go into cover chute 80.

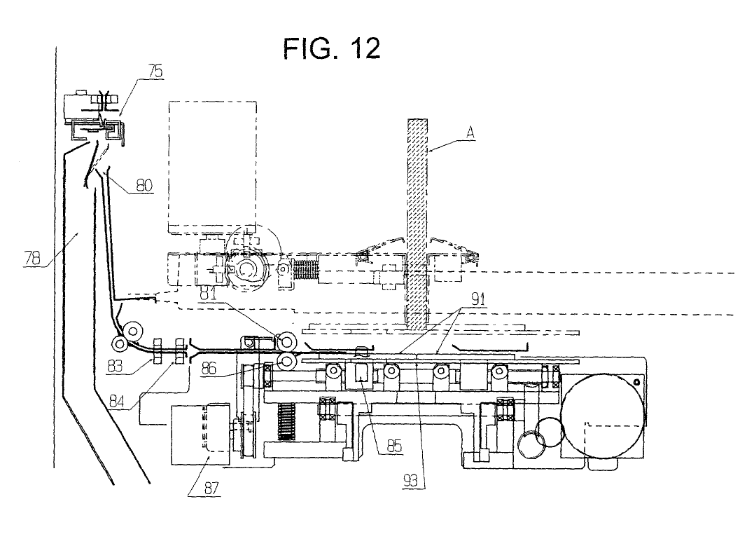

The cover travel path is bent beneath the exit of cover chute 80 and guide rollers 83, 84 to provide a substantially horizontal travel plane leading to the bookbinding position (FIG. 1). Within this horizontal travel plane of the trimmed cover sheet B′, there are located positioning rollers 81 and positioning pin 85, as specifically shown in FIG. 12. Positioning roller 81 is usually kept in press contact with a lower opposite roller 86 but is separable therefrom by an elevating mechanism 87. More particularly, positioning roller 81 is elevated to separate from roller 86 just before the trimmer cover B′ reaches a predetermined position where the back surface of page stack A is adhesively bonded to the center portion of the trimmed cover B′ and the latter is folded along the opposite side edges of page stack A. Positioning pin 85 is elevatable between the operative position shown in FIG. 12 and a lower stand-by position, as well as movable horizontally, that is, in parallel with the cover travel path near the bookbinding position. Positioning pin 84 is elevated from the stand-by position to the operative position and moved forward in the cover feeding direction, while positioning roller 81 is kept standstill apart from the lower roller 86, so that it cooperate with a stationary guide to be described hereinlater in reference to FIG. 16 for exact adjustment of position of the trimmed cover sheet B′ which has been fed nearly to the bookbinding position. Then, positioning roller 81 is lowered and driven to the trimmed cover sheet B′ to the bookbinding position.

In the embodiment of FIG. 2, functions of press unit 8 and folding unit 9, both in FIG. 1, are achieved by a single unit, bookbinding unit 90, which comprises a pair of forming plates 91, 91, a drive mechanism 92 for opening and closure of forming plates 91, 91, a movable plate 93 just beneath forming plates 91, 91, a shift mechanism 94 for moving plate 93 on a horizontal plane, an elevating mechanism 95 for elevation of entirety of bookbinding unit 90 between a stand-by position by solid lines and an operative position shown by dotted lines. Forming plates 91, 91 are arranged in a symmetric design with respect to the center of thickness of page stack A which is clamped upstanding by main damper 50, whenever they are opened or closed.

Movable plate 93 has a slit, now shown, which is broad enough to pass therethrough maximum thickness (20 mm, for example) of a booklet which can be produced by the bookbinder of this embodiment. When movable plate 93 is located at a position shown in solid and dotted lines in FIG. 2, the slit position is not aligned with an opening between forming plates 91, 91, which becomes vertically aligned with the opening when bookbinding unit 90 is slightly moved from that position to right, in FIG. 2 by shift mechanism 94. The former position is defined as a shut-off position and the latter as a straightway position.

Beneath bookbinding unit 90 is arranged booklet conveyor unit 10 (FIG. 1) which, in the embodiment of FIG. 2, comprises the slit of movable plate 93 when it is aligned with the opening between forming plates 91, 91, and a guide wall 96 for guiding booklet C falling down through the slit toward a belt conveyor 97 by which booklet C is conveyed to a predetermined safekeeping station.

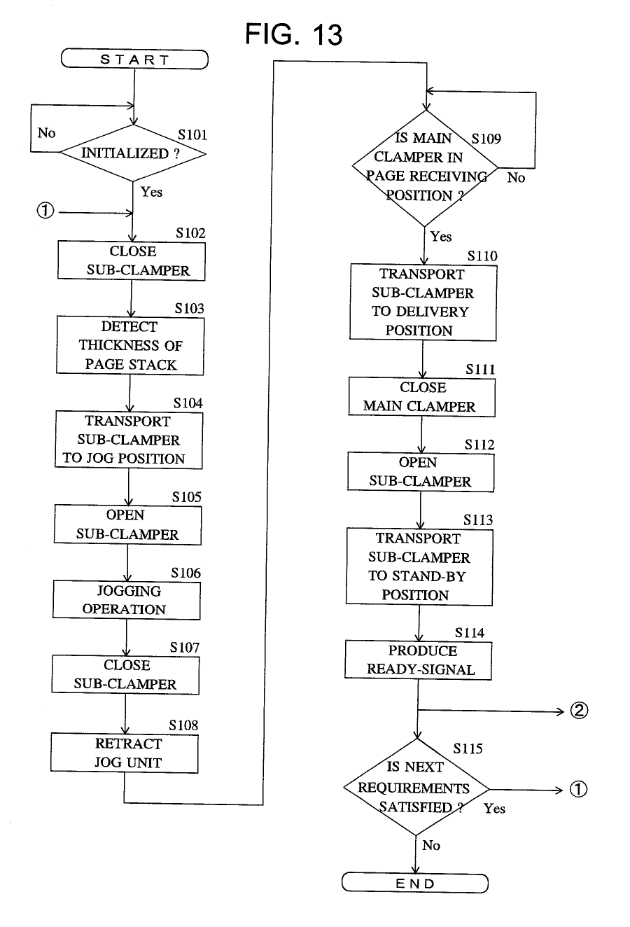

Operation of the respective elements of the above-described bookbinding device is controlled by a controller, not shown, which will be described in detail in reference to flowcharts of FIGS. 13-15.

Referring specifically to the flowchart of FIG. 13 illustrating page supply operation of this bookbinding device including supply of page stack A by sub-clamper 20, jogging thereof by jog unit 40 and delivery thereof from sub-clamper 20 to main clamper 50, it is first confirmed at S101 if all the initial requirements are satisfied. The initial requirements may include, for example, that sub-clamper 20 is in the delivery position, that jog unit 40 is in the stand-by position, that some page stack A is set on table 24 of sub-clamper 20, that some cover page B of a size corresponding to the size of page stack A on table 24 is contained in cassette 71 of cover supply unit 70 (which is confirmed by the page size sensor and the cover size sensor), that a necessary amount of molten adhesive 61′ is contained in housing 65 of heater unit 60, a starter switch (not shown) of the bookbinding device is already ON, etc.

After confirming that all the initial requirements are satisfied at S101, clamping plate 25 of sub-clamper 20 is moved down toward table 24 to clamp page stack A therebetween (at S102), followed by detection of thickness of the clamped page stack A by sensor 21 (at S103). The bookbinding device according to the embodiment of FIG. 2 is capable of binding page stack A of thickness ranging from 1.5 mm to 20 mm. When the result of detection by sensor 21 is smaller or larger than that range, sub-clamper 20 is opened to unclamp page stack A and an error message appears on a display, not shown, of the device.

Then, at S104, sub-clamper 20 is moved to the jog position and stopper 28 is rotated to the retracted position shown by dotted lines in FIG. 2 to disengage the front end of the clamped page stack A. At S105, jog unit 40 is moved by drive mechanism 41 from the stand-by position to the operative position shown by solid lines in FIG. 2, and clamping plate 25 is slightly opened to unclamp page stack A, followed by jogging operation for a predetermined period of time (at S106). The jogging operation carried out by jog unit 40 has been described in detail in reference to FIGS. 5, 6, 10 and 11. During the jogging operation, main damper 50 which has carried out the bookbinding operation at the bookbinding position is moved to the page receiving position, and another cover page B is supplied from cassette 71 of cover supply unit 70.

After the jogging operation is over, clamping plate 25 is again moved toward table 24 to clamp page stack A therebetween (at S107), and jog unit 40 is moved to the retracted position shown by double-dotted lines in FIG. 2 (at S108).

Then, after confirming at S109 that main camper 50 has already been returned to the page receiving position, sub-clamper 20 which clamps the jogged page stack A is moved to the delivery position by drive mechanism 22 (at S110). Main damper 50 is opened as shown in FIG. 4(a) at this time. Then, main damper 50 is closed at S11 and sub-clamper 20 is opened at S112. As described before, projections 24a, 25a formed at the front end of sub-clamper 20 enter recesses 51b, 52b of clamping plates 51, 52 of main damper 50 whereas projections 51a, 52a of main camper 50 go into recesses 24b, 25b of sub-clamper 20, as shown in FIG. 4(b), so that page stack A may be surely delivered from sub-clamper 20 to main damper 50 while keeping the jogged condition, as shown in FIG. 4(c).

Sub-clamper 20 that is opened at S112 is returned to the stand-by position for waiting supply of another page stack A onto table 24 (at S113). A signal indicating that main damper 50 clamping the jogged page stack A becomes ready to move from the page receiving position to the glueing position (at S114). Then, after confirming at S115 that all the requirements for subsequent bookbinding operation are fulfilled, the procedure is returned to S102. The requirements for subsequent bookbinding operation may include, for example, that a page stack A is set on table 24 of sub-clamper 20, the start switch is ON, etc. If any one of such requirements is not satisfied within a predetermined time limit, it is discriminated that the bookbinding operation has been finished, and the device is made inoperative.

Referring now to the flowchart of FIG. 14 which illustrates successive operation of this bookbinding device including glueing to a back surface of page stack A, adhesive bonding of page stack A to the trimmed cover sheet B′ and folding of the latter, the procedure start with a step S201 for confirming that the ready signal has been output at S114, followed by a step S202 for moving main damper 50 from the page receiving position to glueing position. It is to be reminded that the page receiving position of main damper 50 is somewhat offset to right, in FIG. 2, with respect to the center axis of heater roll 64. Main damper 50 is moved from this position to the glueing position where the center of thickness of the upstanding page stack A clamped by main damper 50 is just aligned with the center axis of heater roll 64, in reference to thickness of the page stack A clamped by sub-clamper 20, which has been detected by sensor 21 at S103 of the flowchart of FIG. 13.

Next, at S203, heater roll 64 is elevated by elevating mechanism 67. Heater roll 64 is usually caused to rotate in a predetermined direction (in a clockwise direction in FIG. 7) by rotary drive mechanism 66 so that the periphery at the top will carry a predetermined amount of molten adhesive 61′. Before heater roll 64 begins ascending, it stops rotating. At the elevated position, heater roll 64 comes into contact under pressure with the back surface of page stack A clamped upstanding by main damper 50 at the glueing position, and then starts rotating or swinging for a predetermined period of time in opposite directions within a predetermined small angle (±5 degrees, for example) at S204, so that molten adhesive 61′ may not only be applied to the back surface of the clamped page stack A but also go into gaps between adjacent pages of stack A. Such swinging rotation of heater roll 64 will cause vibration of the back surface of page stack A to create an interstice between every adjacent pages, which is enough to receive a part of molten adhesive 61′ adhering to the periphery of heater roll 64 so that molten adhesive 61′ is not only applied to the back surface but also to side edge areas of each page to drastically improve binding strength.

After executing the glueing operation by swinging rotation of heater roll 64 for a predetermined period of time, heater roll 64 is moved down to the stand-by position, at S205.

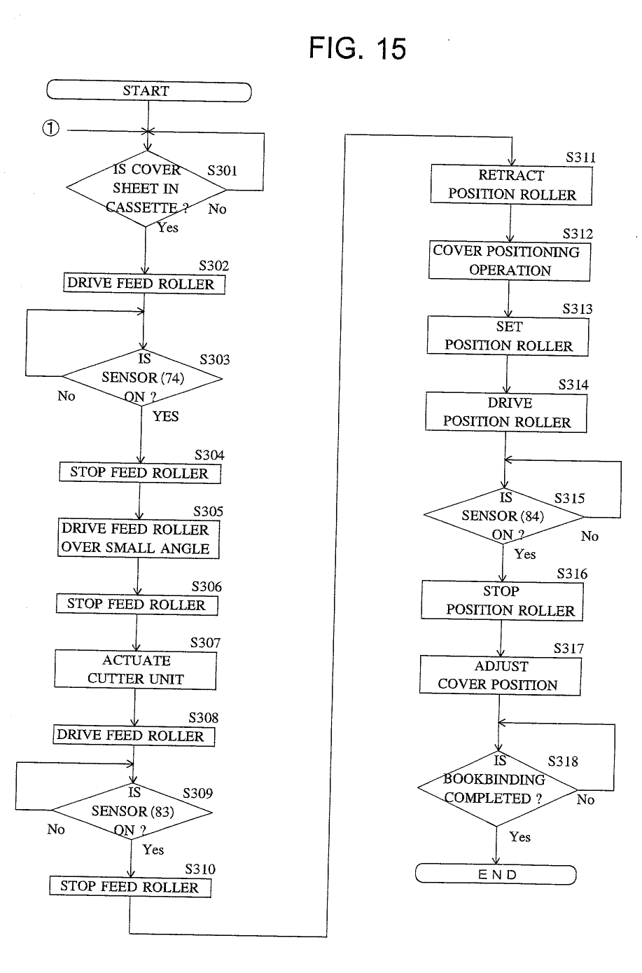

Then, it is confirmed at S206 if the trimmed cover sheet B′ has been supplied to a predetermined position on forming plates 91,91 of bookbinding unit 90, and main damper 50 is further moved to left, in FIG. 2, to the bookbinding position (at S207). At the bookbinding position of main damper 50, the center of thickness of the glued back surface of page stack A clamped thereby is just aligned with the center of forming plates 91, 91. The center of the trimmed cover sheet B′ supplied into position is also aligned with the center of forming plates 91, 91. The positioning of cover sheet B′ will be described hereinlater in reference to the flowchart of FIG. 15.

Referring again to the flowchart of FIG. 14, forming plates 91, 91 are opened by drive mechanism 92 (at S208), and bookbinding unit 90 is elevated by elevation mechanism 95 from the stand-by position shown by solid lines in FIG. 2 to the operative position shown by dotted lines in FIG. 2 (at S209). During elevation of bookbinding unit 90, the glued back surface of page stack A clamped upstanding by main damper 50 at the bookbinding position enters a gap between the opened plates 91, 91 and contacts under pressure with plate 93 with cover sheet B′ being interposed therebetween, so that the back surface of page stack A is bonded to the center position of cover sheet B′ by hot melt adhesive 61′ on the back surface of page stack A. Furthermore, as repeated in the foregoing description, each adjacent pages of page stack A is bonded to each other by a small quantity of hot melt adhesive 61′ entering interstices at the back edge portions thereof during forward and reverse rotation of heater roll 64. Position of movable plate 93, when elevated, is shown by double-dotted lines in FIG. 12, but it is to be noted that forming plates 91, 91 are shown as in the closed position, which is achieved at S210.

Yes, the step to be done subsequent to S209 is to close forming plates 91, 91 while bookbinding unit 90 is kept standstill at the elevated position, whereby cover sheet B′ is folded inwardly along opposite side edges of the back surface of page stack A. A pressure level to be applied by closure of forming plates 91, 91 is detected by a pressure sensor, not shown, at S211. The bookbinding operation at S209 begins when the forming pressure reaches a predetermined level and ends when a predetermined period of time (2 seconds, for example) passes, which is detected at S212.

After the bookbinding operation is finished (at S213), plate 93 is moved by drive mechanism 92 from the shut-off position to the straightway position where the slit or booklet passage thereof is aligned below with the center of forming plates 91, 91, which are then opened (at S214), and main damper 50 is then opened to unclamp page stack A which is now bonded to cover sheet B′ into a unitary assembled booklet C (at S215). Thus, booklet C passes through the gap between the opened forming plates 91, 91 and the slit of movable plate 93, due to its own weight, and is guided along guide wall 96 onto running belt conveyor 97. Belt conveyor 97 is provided with a sensor, not shown, at any position downstream of the lower end of guide wall 96, which sends a detection signal each time when booklet C has passed the sensor position. When outputting the detection signal (Yes at S216), bookbinding unit 90 is moved from the upper, operative position to the lower, stand-by position (at S217), and plate 93 is returned to the shut-off position (at S218). Finally, main clamp 50 is returned to the stand-by position shown by solid lines in FIG. 2 (at S219).

A series of the above-described steps from S201 to S219 is executed each time in response to the signal output at S114 of the flowchart of FIG. 13 for automated continuous bookbinding operation.

Reference should now be made to the flowchart of FIG. 15 which illustrates cover supply operation of this bookbinding device including trimming of cover sheet B, discharge of scraps and positioning of the trimmed cover sheet B′.

After confirming at S115 of the flowchart of FIG. 12 that all the requirements for subsequent bookbinding operation are fulfilled, it is confirmed if at least one cover sheet B is received in cassette 71, at S301. When this is confirmed (Yes at S301), first feed roller 72 is driven to feed one cover sheet B among those received in cassette 71 along the cover travel path defined by feed rollers 73, at S302. Cutter position sensor 74 located upstream in vicinity to cutter 75 is turned on when it detects passing therethrough of the forward end of cover sheet B, which is confirmed at S303 to stop feed roller 72 at S304. Then, feed roller 72 is again driven to rotate over a small angle to feed cover sheet B by a predetermined distance (L1) at S305, followed by again stopping feed roller 72 at S306. Consequently, the forward end portion of cover sheet B extending downward beyond the position of cutter blade 75a has a length (L1−L2), where (L2) designates a distance of the cover travel path extending between the sensor position to the cutter blade position. Then, cutter blade 75a is moved perpendicular to the cover travel path so as to cut or trim the extending forward end portion of cover sheet B, at S307.

Cover sheet B received in cassette 71 has a predetermined size which depends on a size of page stack A to be bound. More particularly, a length (WB) of cover sheet B in its travelling direction is determined by the following equation (1), where (WA) represents a width of page stack A, (V) a cutting margin corresponding to a thickness of cutter blade 75a, (α) a margin left for applying hot melt adhesive by heater unit 60 and folding cover sheet B′ by bookbinding unit 90, and (Tmax) the maximum thickness of a booklet which may be produced by using this bookbinding device:

WB=(WA+α)×2+Tmax+V (1)

Supposing (TA) represents the thickness of page stack A detected by sensor 21, the length (L1−L2) of the forward end portion of cover sheet B to be trimmed by cutter 75 should be a difference between the maximum bookbindable thickness and the actual thickness, that is (Tmax−TA). Accordingly, the feed amount (L1) at S305 should be determined by the following equation (2):

L1=Tmax−TA+L2 (2)

The length (WB′) of cover sheet B′ after being trimmed is expressed by the following equation (3):

WB′=(WA+α)×2+TA (3)

Feed roller 72 is again driven to resume feeing the trimmed cover sheet B′ (at S308) until sensor 83 is turned on by detecting passing of the rear end of the trimmed cover sheet B′ (at S309). When sensor 83 is turned on (Yes at S309), feed roller 72 is brought to a stop (at S310) and positioning roller 81 is elevated to separate from the opposing roller 86 (at S311), followed by definite positioning of cover sheet B′ by controlled movement of positioning pin 85 (at S312).

Positioning pin 35 is arranged to be engageable with one side edge of cover sheet B′ when cover sheet B′ is fed to the bookbinding station, which cooperates with opposing stationary guide pins 88, 88 (FIG. 16) to slightly move cover sheet B′ toward a definite position where the glued back surface of page stack A is adhesively bound to the center of cover sheet B′. Positioning pin 35 stands by at a lower position below the cover travel path but is elevated at S312 to come into engagement with the one side edge of cover sheet B′, and is further elevated to lift the said one side edge of cover sheet B′, which is slightly moved forward at a low speed so that the opposite side edge of cover sheet B′ engages with stationary guide pins 88, 88 which defines the side edge position or alignment of cover sheet B′ with respect to position of page stack A carried by main damper 50 at the bookbinding position. In summary, the operation at S312 is to amend positioning of cover sheet B′ at the bookbinding station, especially in a direction perpendicular to the cover travel path.

After completing the cover positioning operation at S312, positioning pin 35 descends toward the stand-by position, positioning roller 81 is moved downward for press-contact with opposing roller 86 (at S313) and driven to resume feeding cover sheet B′ (at S314). When sensor 84 is turned on by detecting passage of the rear end of cover sheet B′ (Yes at S315), positioning roller 81 comes to a stop (at S316) so that cover sheet B′ is fed to a reference position on forming plates 91, 91 but still does not reach a position suitable to bookbinding which should vary depending upon the thickness (TA) of page cover A. The reference position of cover sheet B′ at S316 may be determined as a position where its center of width is aligned with the center of thickness of page stack A clamped by main clamper 50 which has been moved to the bookbinding position (at S207 of the flowchart of FIG. 14), when (TA) is equal to (Tmin), (Tmin) representing the minimum thickness of a booklet which may be produced by this bookbinding device, that is 1.5 mm in this embodiment. The reference position determined as described above is offset from the center of thickness of page stack A at the bookbinding position by half a difference between the actual thickness and the minimum thickness of the booklet, that is (TA−Tmin)/2.

Thus, the cover positioning operation ends at S317 where positioning roller 81 is driven to feed cover sheet B′ by an offset amount calculated by the above equation, for awaiting completion of the bookbinding operation at S318. When the bookbinding operation is finished (Yes at S318), a series of the above-described steps from S301 to S318 of the flowchart of FIG. 15 is over.

As apparent from the foregoing description, because a bookbinding device according to the present invention involves a step of trimming a side edge portion of a cover sheet in dependence upon thickness of a page stack, a post-trimming step may be omitted and it becomes possible to produce booklet C having a cover of a size exactly corresponding to a size of page stack A. The concept underlying the present invention allows printing to be applied to the cover page during the bookbinding operation, because the exact center position of the cover page, after being trimmed, may be determined, which means that the present invention is useful in full-page printing.

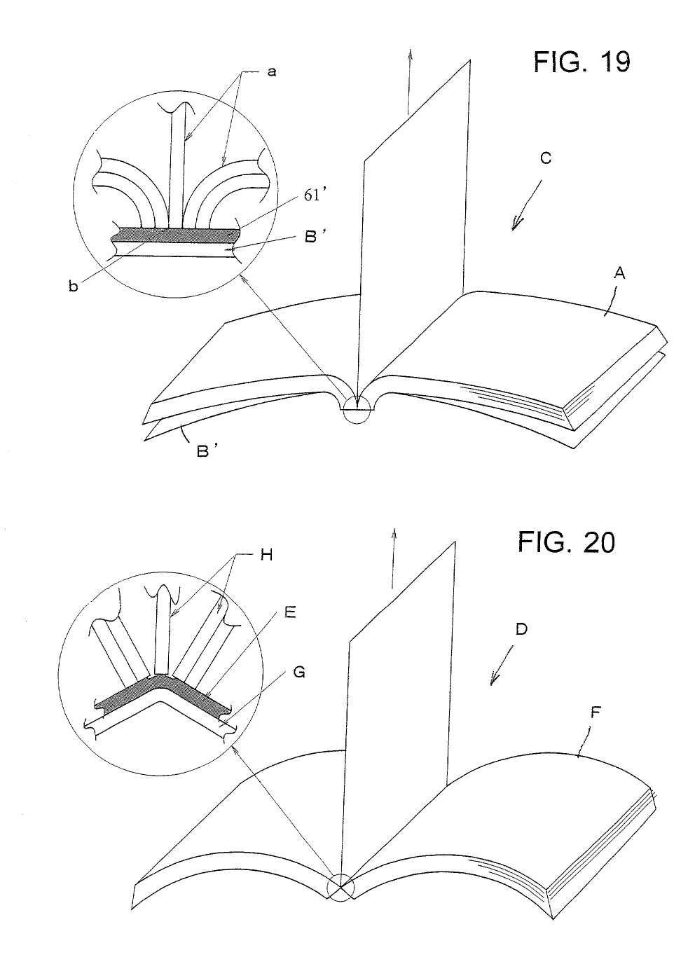

A booklet C produced in accordance with the bookbinding device of the present invention is shown by way of example in FIG. 19. As described more than once in the foregoing description, a part of molten adhesive 61′ applied to the back surface of page stack A at S203 of the flowchart of FIG. 14 enters every interstice between adjacent pages a, a, of page stack A, so that the adjacent pages a, a, . . . may be bonded to one another with molten adhesive 61′ applied to side edge areas b, b, . . . surrounding the back surface. This will drastically improve binding strength or page holding strength and prevent loss of pages when the user is leafing booklet C.

Although the present invention has been described in conjunction with specific embodiments thereof, it is to be understood that the present invention is not limited to these embodiments and many modifications and variations may be made without departing from the scope and spirit of the present invention as specifically defined in the appended claims.

What is claimed is:

1. A glueing device for adhesive bookbinding of a page stack to a cover sheet, which comprises:
a housing for containing hot melt adhesive in a molten state;
a coating roller with a periphery, at least a part of which is immersed in the molten adhesive in said housing, having an axial length substantially greater than a lengthwise size of the back surface of the page stack, said roller being rotatable about a shaft extending substantially in alignment with a center of thickness of the page stack;
a first drive mechanism for achieving press-contact between the periphery of said coating roller and the back surface of the page stack to apply the molten adhesive on the periphery of said coating roller to the back surface of the page stack; and
a second drive mechanism for rotating said coating roller in forward and reverse directions over a predetermined small angle range, while the periphery of said coating roller is being in press-contact with the back surface of the page stack by said pressure applying mechanism, so that the molten adhesive effectively enters in substance every interstice between adjacent pages from the back surface of the page stack and, therefore, not only the back surface of the page stack but also opposing areas, in vicinity to the back surface, of the adjacent pages are coated with the molted hot melt adhesive for improved bonding therebetween.

2. The glueing device according to claim 1 wherein said coating roller is provided with a plurality of spaced, ringed grooves around a periphery thereof.

3. The glueing device according to claim 1 which further comprises:
a adhesive supply unit for supplying the molten adhesive into said housing;
a first sensor for detecting if the molten adhesive is contained in said housing above a first predetermined level; and
a controller for controlling said adhesive supply unit such that it drives said adhesive supply unit for supplementation of the molten adhesive in said housing when said first sensor detects that a quantity of the molten adhesive in said housing does not reach said first predetermined level, whereas it makes said adhesive supply unit inoperative when said first sensor detects that the molten adhesive is contained in said housing above said first predetermined level.

4. The glueing device according to claim 3 which further comprises a second sensor for detecting if the molten adhesive is contained in said housing above a second predetermined level, higher than said first predetermined level, wherein said adhesive supply unit is stopped by said controller when said second sensor detects that the molten adhesive is contained in said housing above said second predetermined level.
